(19) United States
(12) Patent Application Publication
(10) Pub. No.: US 2020/0021708 A1
(43) Pub. Date: Jan. 16, 2020

(54) IMAGE FORMING APPARATUS

(71) Applicant: TOSHIBA TEC KABUSHIKI KAISHA, Tokyo (JP)

(72) Inventors: Takahiro KOJIMA, Mishima Shizuoka (JP); Masahiro KODO, Izunokuni Shizuoka (JP)

(21) Appl. No.: 16/364,804

(22) Filed: Mar. 26, 2019

(30) Foreign Application Priority Data
Jul. 10, 2018 (JP) 2018-130919

(51) Int. Cl. H04N 1/00; H04N 1/028; H04N 1/06; G03G 15/16

(52) U.S. Cl. CPC H04N 1/00978; G03G 15/16; H04N 1/0635; H04N 1/0282

(57) ABSTRACT

An image forming apparatus includes a first temperature sensor inside the image forming apparatus and configured to detect a temperature. A controller is configured to execute a first position shift correction for each of a plurality of toner images used in printing an image when the first temperature sensor detects a change in temperature from a previously detected temperature exceeds a first threshold value set for a first temperature range. After the first position shift correction, the controller executes a second position shift correction if the detected change exceeds a second threshold value set for a second temperature range higher than the first temperature range and the temperature is outside a prescribed temperature range, and skips the second position shift correction otherwise.

### CROSS-REFERENCE TO RELATED APPLICATION

This application is based upon and claims the benefit of priority from Japanese Patent Application No. 2018-130919, filed Jul. 10, 2018, the entire contents of which are incorporated herein by reference.

### FIELD

Embodiments described herein relate generally to an image forming apparatus.

### BACKGROUND

In order to realize color printing, the image forming apparatus superimposes images formed by toners of different colors. Here, a color shift in which the superimposition of the different toner images is not ideal may result when the different toner images are shifted in position from each other because of misalignments of the different imaging units for each. The cause of color shift may be a displacement in each color unit due to the temperature variation of optical scanning devices or the like. For this reason, the image forming apparatus generally corrects color shifts by executing an alignment process when the temperature of an optical scanning device changes by a certain level or more.

### DESCRIPTION OF THE DRAWINGS

FIG. 1 depicts an image forming apparatus common to several embodiments of the present disclosure.

FIG. 2 is a top view illustrating an example of an optical scanning device.

FIG. 3 is a bottom view illustrating an example of an optical scanning device.

FIG. 4 is a cross-sectional perspective view illustrating an example of an optical scanning device.

FIG. 5 schematically depicts an image forming apparatus common to several embodiments of the present disclosure.

FIG. 6 is a graph depicting a temperature change detected by a first temperature sensor according to a first embodiment.

FIG. 7 is a flowchart depicting a timing control of the position shift correction according to the first embodiment.

FIG. 8 is a diagram illustrating a second position shift correction control according to the first embodiment.

FIG. 9 is a graph depicting a temperature change detected by first and second temperature sensors according to a second embodiment.

### DETAILED DESCRIPTION

According to one embodiment, an image forming apparatus includes a first temperature sensor inside the image forming apparatus that is configured to detect a temperature. A controller is configured to execute a first position shift correction for each of a plurality of toner images used in printing an image when the first temperature sensor detects a change in temperature from a previously detected temperature exceeds a first threshold value set for a first temperature range. After the first position shift correction, the controller executes a second position shift correction if the detected temperature change exceeds a second threshold value set for a second temperature range higher than the first temperature range and the temperature is outside a prescribed temperature range, and skips the second position shift correction otherwise.

Several example embodiments of an image forming apparatus are described with reference to the accompanying drawings. In the drawings, a scale of each part may be changed drawing to drawing and from actual size. For convenience of description, various components may be omitted as required for depicting other aspects.

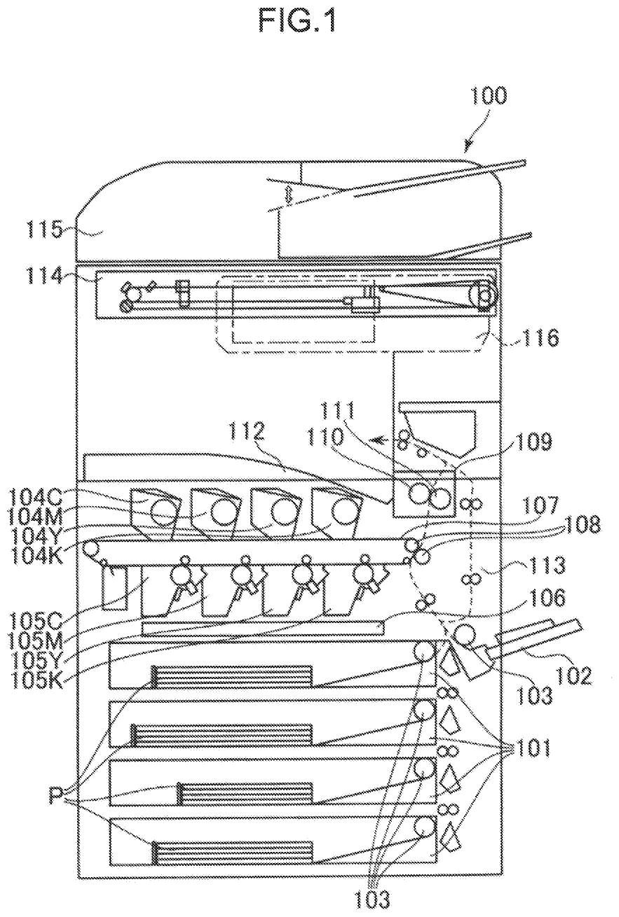

FIG. 1 is a diagram schematically illustrating an example of an image forming apparatus 100 common to several different embodiments. The image forming apparatus 100 is described with reference to FIG. 1.

The image forming apparatus 100 performs printing according to an electrophotographic system. The image forming apparatus 100 is, for example, a MFP (multifunction peripheral), a copying machine, a printer, a facsimile, or the like. For example, as shown in FIG. 1, the image forming apparatus 100 includes a paper feed tray 101, a manual feed tray 102, a paper feed roller 103, a toner cartridge 104C, 104M, 104Y, 104K, an image forming section 105C, 105M, 105Y, 105K, a transfer belt 107, a transfer roller 108, a fixing section 109, a heating section 110, a pressure roller 111, a paper discharge tray 112, a duplex unit 113, a scanning section 114, a document feeder 115 and a control panel 116.

The image forming sections 105C, 105M, 105Y, 105K each perform printing according to an electrophotographic system. In other words, each image forming section 105C, 105M, 105Y, 105K forms an image using toner on an image forming medium P or the like. The image forming medium P is, for example, a sheet of paper. In some examples, image forming medium P may be referred to as paper P or sheet P for simplicity. The scanning section 114 reads an image from a document on which the image is formed. For example, the image forming apparatus 100 performs copying of the document by printing an image read from a document by the scanning section 114 on to an image forming medium P using the image forming sections 105C, 105M, 105Y, 105K.

The paper feed tray 101 accommodates the image forming medium P used for printing.

The manual feed tray 102 is a plate-like element used for manually feeding an image forming medium P.

The paper feed roller 103 rotates by an operation of a motor to convey the image forming medium P accommodated in the paper feed tray 101 or the manual feed tray 102 from the paper feed tray 101 or the manual feed tray 102.

The toner cartridges 104C, 104M, 104Y, 104K store toner to be supplied to the image forming sections 105C, 105M, 105Y, 105K. The image forming apparatus 100 includes a plurality of toner cartridges 104. The image forming apparatus 100 includes a plurality of toner cartridges. For example, as shown in FIG. 1, the image forming apparatus 100 includes four toner cartridges (a toner cartridge 104C, a toner cartridge 104M, a toner cartridge 104Y and a toner cartridge 104K). The toner cartridges 104C, 104M, 104Y and 104K store toners corresponding to respective colors of CMYK (cyan, magenta, yellow, and key (black)). The color of the toners stored in the toner cartridges is not limited CMYK colors, but may instead be any other color. The toner may be a special toner type. For example, the toner may be a decolorable toner which becomes decolored at a temperature higher than a predetermined temperature threshold may be used.

The image forming sections 105C, 105M, 105Y, 105K each respectively comprise a developing device and a photoconductive drum. The developing device develops an electrostatic latent image on a surface of the photoconductive drum using the toner supplied from a toner cartridge (104C, 104M, 104Y, 104K). As a result, a toner image is formed (“developed”) on the surface of the photoconductive drum. The toner image formed on the surface of the photoconductive drum is transferred onto the transfer belt 107 (referred to as primary transfer). The image forming apparatus 100 includes a plurality of the image forming sections. For example, the image forming apparatus 100 comprises four image forming sections: an image forming section 105C, an image forming section 105M, an image forming section 105Y and an image forming section 105K, as shown in FIG. 1. The image forming section 105C, the image forming section 105M, the image forming section 105Y and the image forming section 105K form images by using supplied toners corresponding to respective CMYK colors.

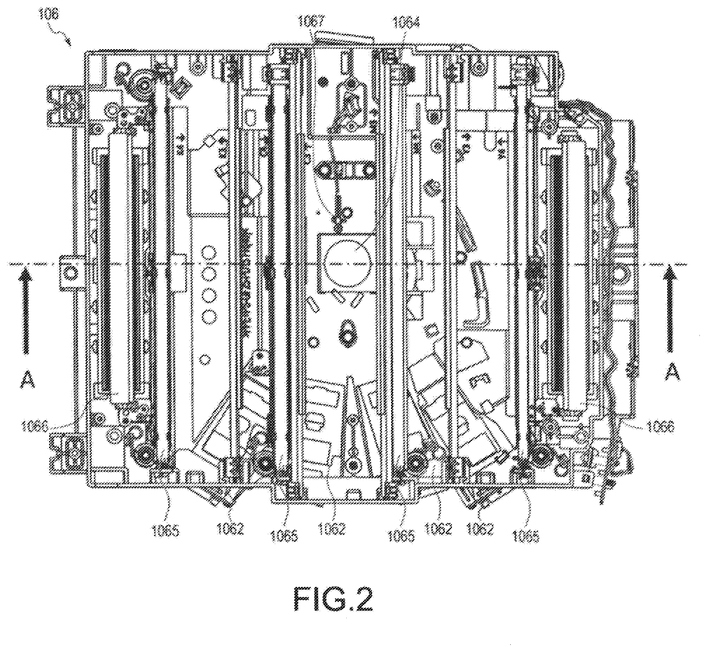

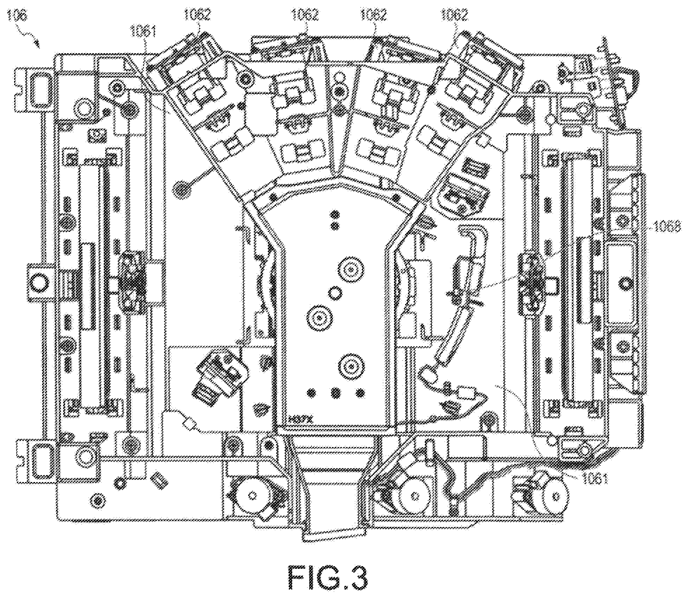

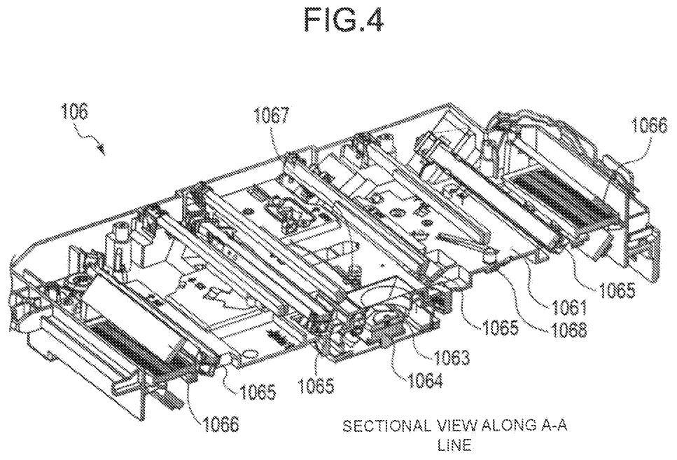

An optical scanning device 106 is described with reference to FIG. 2 to FIG. 4. FIG. 2 is a top view illustrating an example of the optical scanning device 106. FIG. 3 is a bottom view illustrating an example of the optical scanning device 106. FIG. 4 is a cross-sectional perspective view illustrating an example of the optical scanning device 106. FIG. 4 is a cross-sectional view taken along a line AA in FIG. 2.

The optical scanning device 106 is also referred to as an LSU (laser scanning unit) or the like. The optical scanning device 106 forms the electrostatic latent image on the surface of the photoconductive drum of each image forming section 105C, 105M, 105Y, 105K using laser beam controlled according to image data. For example, the optical scanning device 106 includes a housing 1061, a laser unit 1062, a polygonal mirror 1063, a motor 1064, a mirror 1065, a lens 1066, a first temperature sensor 1067 and a second temperature sensor 1068.

In the first embodiment described below, a position shift correction control based on a temperature value (temperature change amount) detected by the first temperature sensor 1067 is described, and in the second embodiment, a position shift correction control based on a temperature value detected by the second temperature sensor 1068 is described. In the first embodiment, the second temperature sensor 1068 is optional and may be omitted in some examples, the image forming apparatus comprising the first temperature sensor 1067 and the second temperature sensor 1068 is described as an example.

The housing 1061 supports the laser unit 1062, the polygonal mirror 1063, the motor 1064, the mirror 1065, the lens 1066, the first temperature sensor 1067 and the second temperature sensor 1068. The housing 1061 is made of resin, for example.

The optical scanning device 106 includes, for example, one laser unit 1062 for each CMYK color (i.e., one laser unit per imaging forming section). Each laser unit 1062 emits a laser beam. Each laser unit 1062 controls emission of the laser beam according to a control signal corresponding to the image data. Each laser unit 1062 modulates the laser beam according to the control signal corresponding to the image data.

The polygonal mirror 1063 reflects the laser beam emitted from each laser unit 1062. The polygonal mirror 1063 is rotated by the motor 1064 to reflect each laser beam for performing scanning.

The motor 1064 rotates the polygonal mirror 1063. Heat generated from the motor 1064 is a main factor in raising the temperature of the optical scanning device 106. Therefore, the motor 1064 is an example of a heat source.

The mirror 1065 and the lens 1066 are optical elements for manipulating the laser beam.

The mirror 1065 is provided in such a manner that a position or an angle thereof with respect to the housing 1061 can be adjusted.

The first temperature sensor 1067 detects a temperature of the inside of the image forming apparatus 100. The first temperature sensor 1067 outputs the detected temperature. The first temperature sensor 1067 is, for example, a thermistor. This is because the thermistor is a relatively inexpensive temperature sensor. For example, the first temperature sensor 1067 is installed near the motor 1064 in the housing 1061, as shown in FIG. 2.

The first temperature sensor 1067 is an example of a temperature detection section that detects a temperature of a portion of the optical scanning device 106.

The second temperature sensor 1068 also detects a temperature of the inside of the image forming apparatus 100. The second temperature sensor 1068 outputs the detected temperature. The second temperature sensor 1068 is, for example, a thermistor. This is because the thermistor is a relatively inexpensive temperature sensor. The second temperature sensor 1068 is installed in the housing 1061. However, the second temperature sensor 1068 is installed at a position further from the motor 1064 than the first temperature sensor 1067. Here, the distance in this case refers to a distance of a path along which heat is transferred in the housing 1061 due to thermal conduction, which may vary from absolute physical distance. For example, the second temperature sensor 1068 is installed adjacent a middle region between an end of the housing 1061 and the motor 1064, as shown in FIG. 3.

The second temperature sensor 1068 detects a temperature of a second portion further from the motor 1064 than the first portion of the optical scanning device 106. The second temperature sensor 1068 is an example of a temperature detection sensor for detecting the temperature of the second portion of the optical scanning device 106.

Returning to FIG. 1.

The transfer belt 107 is, for example, an endless belt, and is rotatable by the operation of a roller. The transfer belt 107 rotates to convey the image transferred from each of the image forming sections to a position adjacent the transfer roller 108.

The transfer roller 108 includes two rollers facing each other. The transfer roller 108 transfers the images formed on the transfer belt 107 onto the image forming medium P passing between both rollers of the transfer roller 108 (referred to as secondary transfer).

The fixing section 109 heats and presses the image forming medium P onto which the toner image has been transferred. As a result, the image transferred onto the image forming medium P is fixed. The fixing section 109 comprises a heating section 110 and a pressure roller 111 facing each other.

The heating section 110 is, for example, a roller provided with a heat source for heating the heating section 110. The heat source is, for example, an inductive or other type heater. The roller heated by the heat source heats the image forming medium P.

Alternatively, the heating section 110 may include an endless belt held by a plurality of rollers. For example, the heating section 110 may include a plate-like heat source, an endless belt, a belt conveyance roller, a tension roller and a press roller. The endless belt is, for example, a thin member. The belt conveyance roller drives the endless belt. The tension roller gives tension to the endless belt. An elastic layer is formed on the surface of the press roller. The plate-like heat source contacts the inner side of the endless belt on a heat generation portion side and is pressed towards the press roller. A fixing nip having a predetermined width is formed by the plate-like heat source and the press roller. Since the plate-like heat source acts as a portion of a nip area while also heating the nip area, responsiveness at the time of energization is higher than that in the case of a heating method using a halogen lamp.

The endless belt is formed by forming a silicone rubber layer having a thickness of 200 μm on an outer side of a stainless steel (SUS) base material having a thickness of 50 μm or a polyimide resin having a thickness of 70 μm, and an outermost periphery thereof is covered with a surface protective layer such as PFA (perfluoroalkoxy alkane) material. The press roller is formed by forming a silicone sponge layer having a thickness of 5 mm on a surface of a steel bar of 00 mm, and the outermost periphery thereof is covered with a surface protective layer such as PFA material.

In the plate-like heat source, for example, a glaze layer and a heat resistance layer are laminated on a ceramic substrate. In the plate-like heat source, a heat sink made of aluminum is bonded thereon to promote removal of excess heat to the opposite side and prevent warping of the substrate. The heat resistance layer is made of a known material such as TaSiO2, for example, and is divided to have a predetermined length and number in a main scanning direction.

The pressure roller 111 presses the image forming medium P against the heating section 110.

The paper discharge tray 112 is a plate or the like to which the printed image forming medium P is discharged.

The duplex unit 113 permits the printing on a back surface of the image forming medium when enabled. For example, the duplex unit 113 reverses the front and back surfaces of the image forming medium P by switching back the image forming medium P using a roller or the like.

The scanning section 114 reads an image from a document. The scanning section 114 is a scanner for reading an image from the document.

The scanner is of an optical reduction system including an image capturing element such as a CCD (charge-coupled device) image sensor, for example. Alternatively, the scanner may be of a CIS (contact image sensor) system including image capturing element such as a CMOS (complementary metal-oxide-semiconductor) image sensor. The scanner may be any other known system.

The document feeder 115 is also referred to as an ADF (auto document feeder), for example. The document feeder 115 conveys the documents placed on a document tray one after another. An image of the conveyed document is read by the scanning section 114. The document feeder 115 may be provided with a scanner for reading an image from a back surface of the document.

The control panel 116 includes, for example, buttons and a touch panel for an operator of the image forming apparatus 100 to operate. For example, the touch panel is formed by laminating a display such as a liquid crystal display or an organic EL (Electro-Luminescence) display on a pointing device for input by touch. Accordingly, the button and the touch panel function as input devices for receiving an operation from the operator of the image forming apparatus 100. The display of the touch panel functions as a display device for providing the operator of the image forming apparatus 100 with various kinds of information.

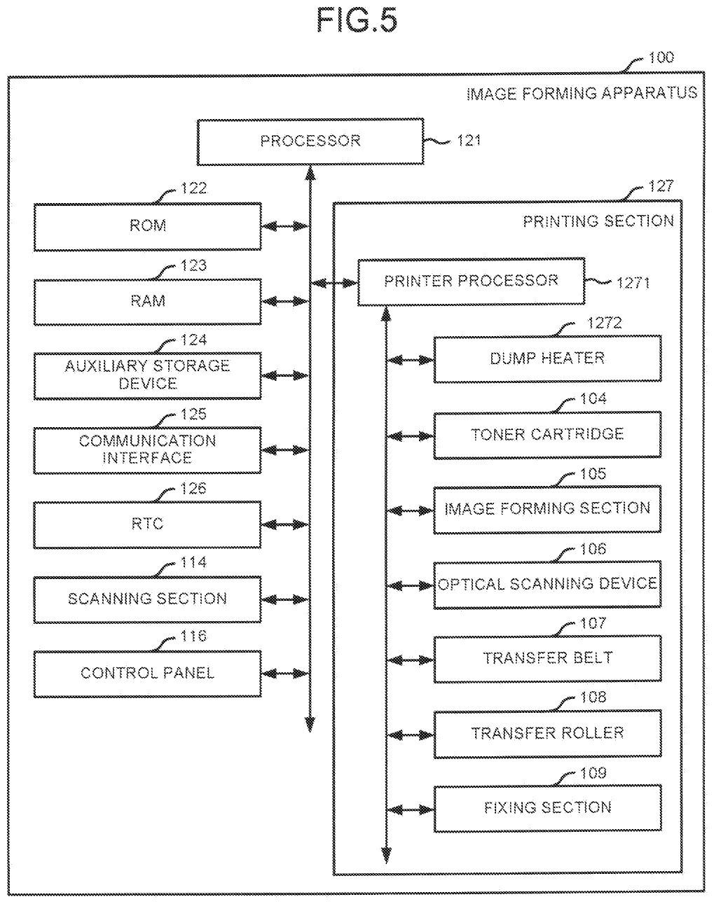

A circuit configuration of main portions of the image forming apparatus 100 is described with reference to FIG. 5. FIG. 5 is a block diagram illustrating the circuit configuration of main portions of the image forming apparatus 100.

For example, the image forming apparatus 100 includes a processor 121, a ROM (read-only memory) 122, a RAM (random-access memory) 123, an auxiliary storage device 124, a communication interface 125, a RTC (Real-Time Clock) 126, the scanning section 114, a printing section 127 and the control panel 116.

The processor 121 performs processing such as an arithmetic processing or a control processing necessary for the operation of the image forming apparatus 100. The processor 121 executes programs such as system software, application software or a firmware stored in the ROM 122 or the auxiliary storage device 124 to control each section to realize various functions of the image forming apparatus 100. The processor 121 is, for example, a CPU (Central Processing Unit), a MPU (Micro Processing Unit), an SoC (System on a Chip), a DSP (Digital Signal Processor), a GPU (Graphics Processing Unit), an ASIC (Application Specific Integrated Circuit), a PLD (Programmable Logic Device) or a FPGA (Field-Programmable Gate Array). Alternatively, the processor 121 may be a combination of the above components.

The ROM 122 is a read-only nonvolatile memory. The ROM 122 stores the programs to be executed by the processor 121. The ROM 122 stores data used for the processor 121 to perform various processing or various setting values.

The RAM 123 is a memory used for reading and writing data. The RAM 123 is used as a so-called work area for storing data temporarily used by the processor 121 to perform various processing.

The auxiliary storage device 124 is, for example, an EEPROM (Electric Erasable Programmable Read-Only Memory), an HDD (Hard Disk Drive), an SSD (Solid State Drive), or the like. The auxiliary storage device 124 may store the programs executed by the processor 121. The auxiliary storage device 124 also stores data used by the processor 121 to perform various processing, data generated in the processing of the processor 121, or various setting values. The image forming apparatus 100 may include an interface into which a storage medium such as a memory card or a USB (universal serial bus) drive can be inserted in addition to or in place of the auxiliary storage device 124.

The programs stored in the ROM 122 or the auxiliary storage device 124 include a program for executing processing according to embodiments of the present disclosure. For example, an administrator of the image forming apparatus 100 causes these programs to be stored in the ROM 122 or the auxiliary storage device 124. However, in some examples, these programs are not initially stored in the ROM 122 or the auxiliary storage device 124 and an administrator or the like installs or loads these programs on the image forming apparatus 100. The programs for executing the processing according to embodiments of the present disclosure may be transferred separately to the administrator and may be subsequently written into the ROM 122 or the auxiliary storage device 124 under the operation of the administrator or a service person. The transfer of the program may be realized by recording the program on a removable, non-transitory storage medium such as a magnetic disk, a magneto-optical disk, an optical disk, a semiconductor memory or the like, or by downloading the program via the network.

The communication interface 125 is an interface through which the image forming apparatus 100 communicates via the network or the like.

The RTC 126 is a circuit including a clock or providing a clock function.

The printing section 127 is used for printing an image on the image forming medium P or the like based on the image data. The printing section 127 includes, for example, a printer processor 1271, a damp prevention heater 1272, a toner cartridge (or toner cartridges, e.g., toner cartridges 104C, 104M, 104Y, or 104K), an image forming section (or image forming sections, e.g., image forming sections 105C, 105M, 105Y, 105K), the optical scanning device 106, the transfer belt 107, the transfer roller 108 and the fixing section 109.

The printer processor 1271 performs processing such as an arithmetic processing and/or a control processing necessary for the printing operation of the image forming apparatus 100. The printer processor 1271 executes the arithmetic processing or the control processing necessary for the printing operation based on an instruction from the processor 121 and various programs. The printer processor 1271 outputs a processing result to the processor 121. Various programs for providing the functions of the printer processor 1271 may be stored in the ROM 122 or the auxiliary storage device 124, or some or all of the functions of the printer processor 1271 may be incorporated in a hardware circuit of the print processor 1271. Alternatively, various programs may be stored in a storage section of the printing section 127. The printer processor 1271 is, for example, a CPU, a MPU, an SoC, a DSP, a GPU, an ASIC, a PLD or a FPGA.

The damp prevention heater 1272 heats the inside of the image forming apparatus 100 to prevent dew condensation. The damp prevention heater 1272 operates when the image forming apparatus 100 has not performed a printing operation or the like after the lapse of some predetermined period of time if a dew condensation prevention function has been started.

### First Embodiment

Next, an example of a timing control for the position shift correction according to the first embodiment is described. In the first embodiment, the timing control for the position shift correction based on a change in a temperature value detected by one thermistor (for example, the first temperature sensor 1067) is described. One of the processor 121 or printer processor 1271 controls the timing of the position shift correction. Alternatively, the processor 121 and the printer processor 1271 may cooperate with each other to control the timing of a position shift correction. At least one of the processor 121 and the printer processor 1271 records the temperature value detected by the first temperature sensor 1067 at a predetermined frequency (rate) in the auxiliary storage device 124 or the like so a temperate change in the temperature value recorded can be detected. The magnitude of the temperature change is used as a criterion for determining whether or not to execute the position shift correction.

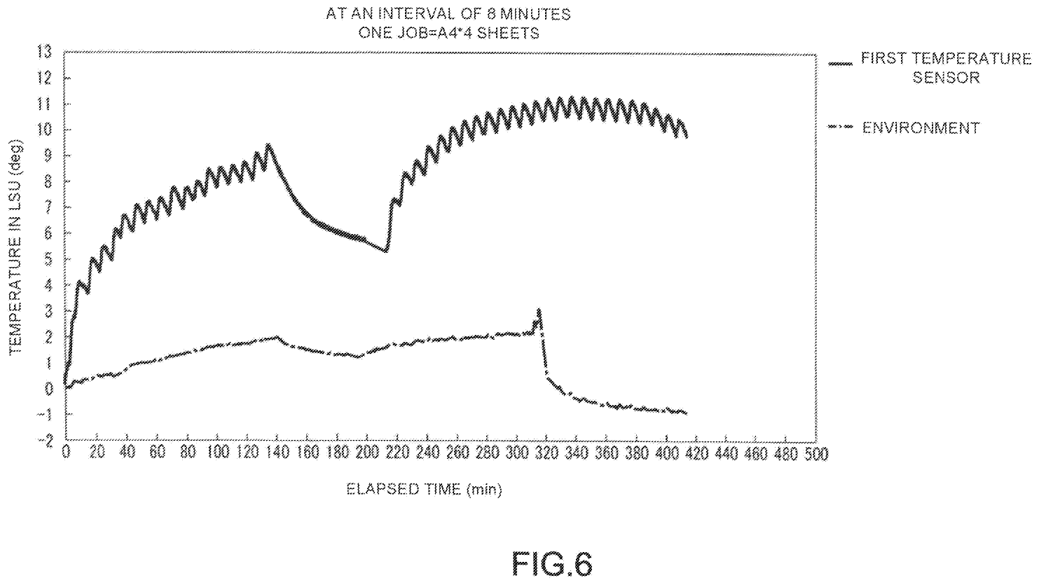

FIG. 6 is a diagram illustrating an example of a temperature change detected over a time of operation by the first temperature sensor 1067 in the case in which a job is executed repeatedly but intermittently (as compared to substantially continuously) at an interval of 8 minutes. For example, each job is the printing on four sheets of paper of an A4 size (A4*4 sheets), and a printing stopping period between the one job and the next is about 8 minutes.

As shown in FIG. 6, for example, an elapsed time of 0 minutes is set as a reference time, the job is repeatedly executed over a period of time of 140 minutes, repetition of the job is stopped at 140 minutes, and then again the job is repeatedly executed after 215 minutes. In a period in which a job is being executed, the temperature value detected by the first temperature sensor 1067 increases, and in the interval between one job and next, the temperature value detected by the first temperature sensor 1067 falls. The inside of the image forming apparatus 100 is gradually warmed by the heat sources, such as the optical scanning device 106 and the damp prevention heater 1272, even if the stopped interval is about 8 minutes, the temperature does not return all the way to the initial temperature at the start of job. Specifically, from 0 to 140 minutes, the temperature value detected by the first temperature sensor 1067 gradually rises overall though repeatedly rising and falling locally with the starting and stopping of each individual job. Similarly, from 215 to 320 minutes, the temperature value detected by the first temperature sensor 1067 again gradually rises overall, though repeatedly rising and falling locally with the starting and stopping of each individual job. A period in which the temperature value detected by the first temperature sensor 1067 gradually rises overall while repeatedly rising and falling locally with the starting and stopping of each job is referred to as a first type temperature change period (for example, the depicted period 0 to 140 minutes and the depicted period of 215 to 320 minutes are each considered first type temperature change periods).

It is depicted here that the ambient temperature is reduced around the elapsed time mark of 320 minutes. In this case, the temperature value detected by the first temperature sensor 1067 after 320 minutes temporarily remains at the same level (plateaus) due to the reduction in the ambient temperature before beginning to fall slowly overall even while repeatedly rising and falling locally with the starting and stopping of each job. As described above, a period in which the temperature value detected by the first temperature sensor 1067 temporarily remains approximately the same level and then falls slowly overall while repeatedly rising and falling locally is referred to as a second type temperature change period (for example, the depicted period after 320 minutes is considered a second type temperature change period).

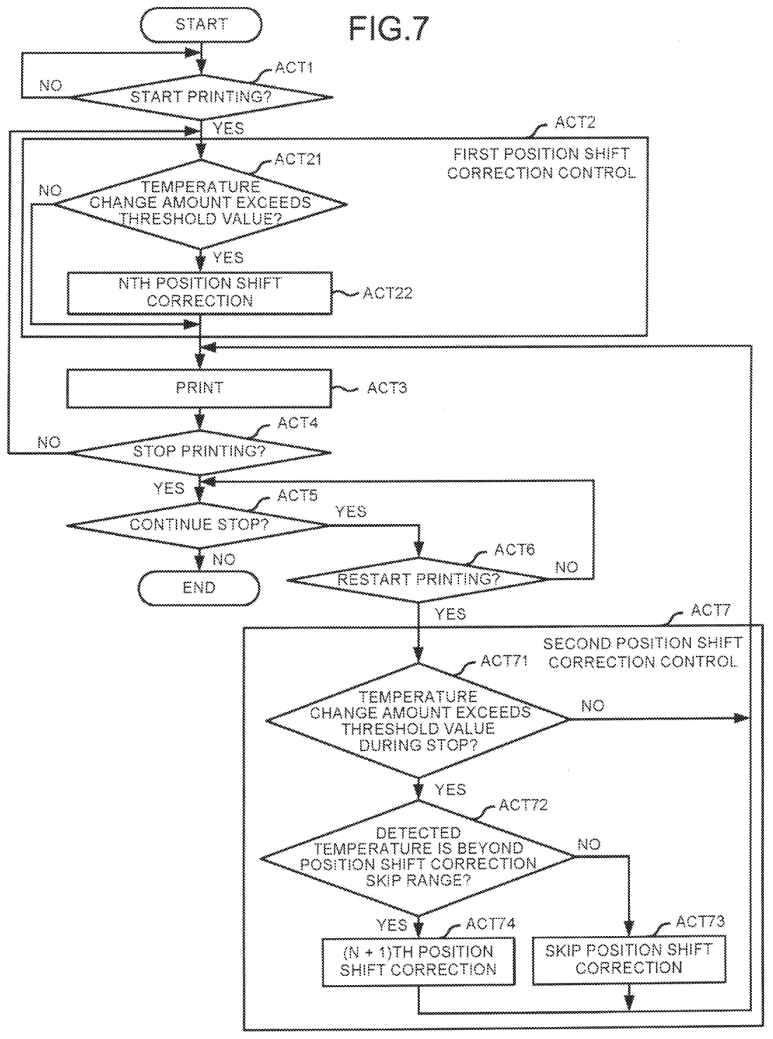

FIG. 7 is a flowchart depicting an example of the timing control of the position shift correction processing according to the first embodiment.

As shown in FIG. 7, the processor 121 and the printer processor 1271 (hereinafter, either one the processor 121 and the printer processor 1271, or the cooperative combination of the two, is referred to as “processor 121 and the like” for simplicity) start printing based on an instruction to start printing from the control panel 116 (Yes in ACT 1). After the start of printing, the processor 121 and the like execute a first position shift correction control with the instruction to start the printing as a reference timing, for example (ACT 2). For example, in the first temperature change period (for example, the time period 0 to 140 minutes and the time period of 215 to 320 minutes), the first position shift correction control is executed.

In the first position shift correction control (ACT 2), when the temperature change from the temperature value detected by the first temperature sensor 1067 does not exceed a threshold value (No in ACT 21), the processor 121 and the like determine that a position shift correction is unnecessary and instruct execution of the job without first executing a position shift correction, and the printing section 127 executes the printing based on the job (ACT 3).

If the temperature change detected by the first temperature sensor 1067 exceeds the threshold value (Yes in ACT 21), the processor 121 and the like determine that a position shift correction is necessary and executes a position shift correction (ACT 22). After the position shift correction, the processor 121 and the like instruct execution of the job, and the printing section 127 executes the printing based on the job (ACT 3).

The position shift correction is an operation primarily for maintaining (adjusting, correcting) superimposition accuracy of a plurality of different color toner images (images in respective colors) corresponding to the colors for color printing. For example, the processor 121 and the like control the image forming sections 105C, 105M, 105Y, 105K, the optical scanning device 106 and the like to form an alignment pattern on the transfer belt 107. The alignment pattern formed on the transfer belt 107 is eventually read by a sensor. The processor 121 and the like acquire information output by the sensor. Then, the processor 121 and the like detect a shift amount between an ideal alignment pattern stored in the auxiliary storage device 124 or the like and the alignment pattern as read, and performs control to change the position or the angle of each mirror 1065, change an exposure timing or the like based on the shift amount, for example. As a result, the processor 121 and the like correct the position shift (relative position shifts) for each color, and the color shift is corrected by position shift(s). The image forming apparatus 100 may correct the position shift by other methods.

In a first threshold value table stored in the auxiliary storage device 124 or the like, a threshold value corresponding to particular temperature change ranges is set using the temperature value detected by the first temperature sensor 1067 as a reference value and the temperature change from the reference value starting at 0 [deg] to indicate no change from the reference value.
0<temperature change range R11<T11: threshold value TH11
T11≤temperature change range R12<T12: threshold value TH12
T12≤temperature change range R13<T13: threshold value TH13
T13≤temperature change range R14: threshold value TH14

Furthermore, the following relationships hold:

T13−T12<T12−T11<T11; and

TH14<TH13<TH12<TH11.

Example values are as follows (expressed as difference from the reference value): T11=5, T12=9, T13=10, with corresponding threshold change values as follows: TH11=2, TH12=1.2, TH13=0.8, TH14=0.6.

The temperature change rate is large in a certain period after the printing has started, and in this period, a relatively large threshold value is adopted. Thereafter, the temperature change rate gradually decreases, and in a period in which the temperature change is small, a relatively small threshold value is adopted. By adopting different threshold values for the periods in which the temperature change is expected to be relatively large, such as immediately after the start of printing, and the periods in which the temperature change is expected to be relatively small, such as after the elapse of a predetermined period of time after the start of printing, the execution timing for the position shift correction can be more appropriately controlled.

For example, if the temperature change from the temperature value detected by the first temperature sensor 1067 at the start of printing (or the last completed correction processing time) exceeds the temperature change range R13 (Yes in ACT 21), the processor 121 and the like determine that the position shift correction is necessary and corrects the position shift (ACT 22).

The processor 121 and the like write the temperature value detected by the first temperature sensor 1067 to the auxiliary storage device 124 or the like as a position shift correction execution temperature value at the time at which it is determined that the position shift correction is necessary (that is, a time just before the position shift correction starts). Alternatively, the processor 121 and the like write the temperature value detected by the first temperature sensor 1067 to the auxiliary storage device 124 as the position shift correction execution temperature value at a time after the execution of the position shift correction (that is, a time immediately after the position shift correction).

Similar to a printing operation, when the position shift correction is executed, the optical scanning device 106 and the like are driven for several to several tens of seconds and this raises the internal temperature. Therefore, the temperature values detected by the first temperature sensor 1067 immediately before the position shift correction and immediately after the position shift correction are generally different. For example, by storing the temperature value detected by the first temperature sensor 1067 as the position shift correction execution temperature value at a time immediately after the position shift correction, an execution frequency of the position shift correction can be suppressed. The effect of suppressing the execution frequency is large in those temperature change ranges (for example, the temperature change ranges R13 and R14) for which a relatively small threshold value is utilized.

As a modification, the temperature change amount may be updated to 0 [deg] immediately before or immediately after the position shift correction described above. Specifically, after the position shift correction is executed, the temperature is detected by the first temperature sensor 1067 at a predetermined timing after execution of the position shift correction by using the temperature at the time of executing the position shift correction as a reference value. Based on the temperature detected by the first temperature sensor 1067, the temperature change from the reference temperature value may be detected at any time, and when the change exceeds a certain threshold value, the position shift correction control (including skipping of the position shift correction processing depending on the condition) may be executed.

For example, if the printing on four sheets of paper of A4 size as one job is performed, the processor 121 and the like continue the printing (No in ACT 4) and repeat the processing in ACT 2 and ACT 3 until the printing of the fourth sheet is terminated. The position shift correction performed last in ACT 22 is referred to as an N^{th} position shift correction. The processor 121 and the like write the position shift correction execution temperature value to the auxiliary storage device 124 as information relating to the N^{th} position shift correction. For example, it is assumed that the N^{th} position shift correction is a correction executed when the temperature change amount exceeds the threshold value TH3. Once the printing on the fourth sheet is terminated, the processor 121 and the like stop printing (Yes in ACT 4), and if a power-off instruction is input through the control panel 116 (No in ACT 5), all operations are terminated. If the power-off instruction is not input, the stopped state is continued (Yes in ACT 5), and the processor 121 and the like wait for a restart of printing (ACT 6).

Thereafter, in response to the instruction to start the printing from the control panel 116, the processor 121 and the like restart the printing (Yes in ACT 6), and executes a second position shift correction control (ACT 7). For example, the second position shift correction control is executed in the second temperature change period (for example, after 320 minutes). If it is determined that the temperature change detected by the first temperature sensor 1067 during the stopped state does not exceed a threshold value TH4 (No in ACT 71), the processor 121 and the like determine that a position shift correction is unnecessary and instruct execution of the job, and the printing section 127 executes the printing based on the job (ACT 3).

If it is determined that the temperature change during the stopped state exceeds the threshold value TH4 (Yes in ACT 71) and also the temperature change is within in a position shift correction skip range (No in ACT 72), the processor 121 and the like determine to skip the position shift correction (ACT 73) and instruct execution of the job. The printing section 127 then executes the printing based on the job (ACT 3). A specific determination for skipping the position shift correction is not always necessary in every embodiment. For example, if it is determined that the amount of temperature change is within the position shift correction skip range (No in ACT 72), the processor 121 and the like may simply instruct execution of the print job directly.

If it is determined that the temperature change detected by the first temperature sensor 1067 during the stopped state exceeds the threshold value TH4 (Yes in ACT 71), and it is also determined that the temperature change is beyond the position shift correction skip range (Yes in ACT 72), the processor 121 and the like determine not to skip the position shift correction. That is, the processor 121 and the like determines that a position shift correction is necessary, and executes a position shift correction (ACT 74). The position shift correction executed in ACT 74 is referred to as a (N+1)^{th} position shift correction. After the position shift correction, the processor 121 and the like instruct execution of the job, and the printing section 127 executes the printing based on the job (ACT 3).

Another case in which a position shift correction is not performed is explained. In the position shift correction control described in the present embodiment, the following case in which the position shift correction is not executed may be adopted.

Even if it is determined that the temperature change detected by the first temperature sensor 1067 exceeds a threshold value during the execution of a job, the processor 121 and the like do not execute the position shift correction if the job ends or is terminated within a predetermined period after the determination. For example, even if it is determined that the temperature change detected by the first temperature sensor 1067 exceeds some threshold value during the printing on the last page during execution of a job or immediately after the printing, the processor 121 and the like will not perform a position shift correction. Thus, the number of executions of the position shift correction can be reduced.

If some minimum period of time for allowing the execution of the next position shift correction does not elapse from when the prior position shift correction was executed, the processor 121 and the like do not execute the position shift correction even if it is determined that the temperature change exceeds a threshold value. As a result, it is possible to suppress excessive execution of position shift corrections that might otherwise be caused by the temperature changes detected by the first temperature sensor 1067 in an extremely short time after the prior correction. When a temperature change occurs within an extremely short time after a prior correction, its influence on the position shift is typically small, and the execution of a position shift correction in response to such a change can be suppressed.

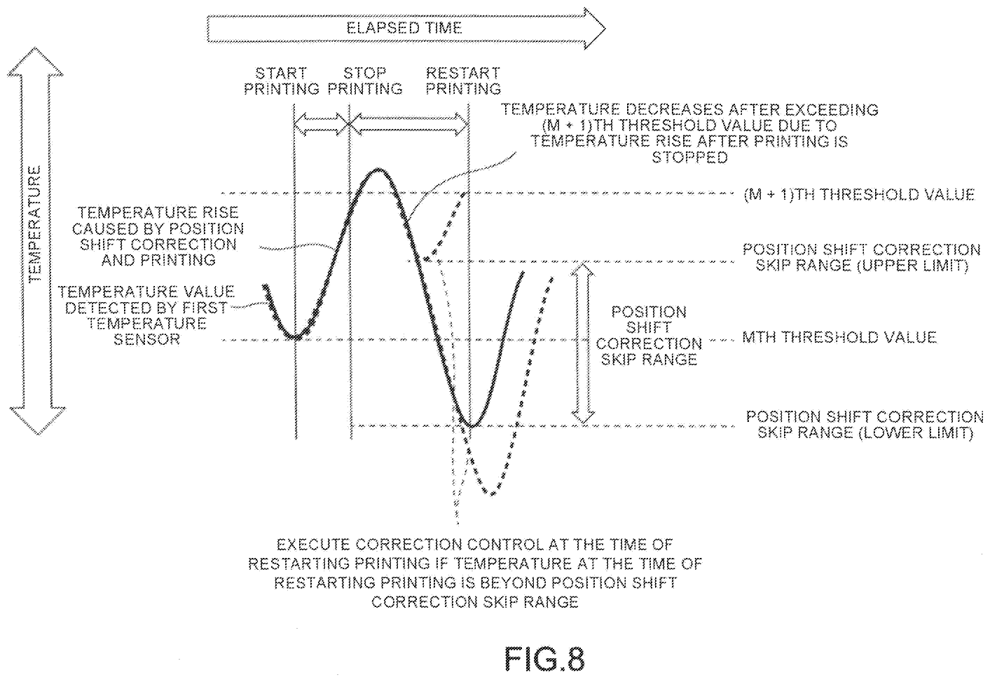

FIG. 8 is a diagram illustrating an example of the second position shift correction control according to the first embodiment, and is a diagram illustrating a part of the temperature change detected by the first temperature sensor 1067 shown in FIG. 6 in an enlarged manner. In FIG. 8, a vertical axis represents the temperature change amount, and a horizontal axis represents the elapsed time. FIG. 8 shows a M^{th} threshold value and a (M+1)^{th} threshold value. In the case of corresponding to the explanation of the flowchart in FIG. 7, for example, the M^{th} threshold value indicates the threshold value TH3, and the (M+1)^{th} threshold value indicates the threshold value TH4. Specifically, the first position shift correction control is executed with the M^{th} threshold value as a trigger (ACT 2), and then the second position shift correction control is executed with the (M+1)^{th} threshold value as a trigger (ACT 7).

As shown in FIG. 8, the temperature value detected by the first temperature sensor 1067 rises after a start of printing due to a first position shift correction control and a printing operation, and continues rising for a while due to the influence of the heat source and the like even after the printing has stopped. After the printing has stopped, the temperature value detected by the first temperature sensor 1067 may eventually exceed the (M+1)^{th} threshold value. Thereafter, the temperature value decreases, and then rises again due to a restarting of printing. The temperature value detected by the first temperature sensor 1067 is recorded in the auxiliary storage device 124 or the like even though the printing is stopped.

In the case in which the processor 121 and the like are to execute the (N+1)^{th} position shift correction control upon the restarting of printing when the temperature change during the stop exceeds a threshold value (for example, threshold value TH4), there may be a case in which the position shift correction control becomes excessive. For example, when the N^{th} position shift correction control was executed when the temperature change exceeded a threshold value (for example, threshold value TH3) before the stopping of the printing, then (N+1)^{th} position shift correction control would be excessive.

For example, there is a case in which the temperature change during the stop in the printing exceeds a threshold value, but the temperature change the time of restarting the printing (or immediately after the printing is restarted) does not exceed the threshold value. In such a case, it is assumed that the previous N^{th} position shift correction control is still valid and the currently contemplated (N+1)^{th} position shift correction control is unnecessary.

Therefore, the processor 121 and the like determine whether to execute the second position shift correction control depending on whether the temperature change at the time of restarting the printing (or immediately after the printing is restarted) is included in a position shift correction skip range (which is a prescribed temperature range). If it is determined that the temperature change during the stop in printing exceeds a threshold value and the temperature change at the time of restarting the printing (or immediately after) is within in the position shift correction skip range, the processor 121 and the like skip the second position shift correction control (do not execute the second position shift correction). If it is determined that the temperature change during the stop in printing exceeds the threshold value and the temperature change amount at the time of restarting the printing (or immediately after) is beyond the position shift correction skip range, the processor 121 and the like execute the second position shift correction control.

For example, the position shift correction skip range includes the M^{th} threshold value as the trigger for the N^{th} position shift correction, and does not include the (M+1)^{th} threshold value as a trigger for the (N+1)^{th} position shift correction. The position shift correction skip range may be a range for which a median value is equal to the M^{th} threshold value used as the trigger for the N^{th} position shift correction. The position shift correction skip range may be any range within a range of 0.5 to 1.5 times the M^{th} threshold value, with the M^{th} threshold value as the trigger for the N^{th} position shift correction as the median value thereof.

The number of times for which the position shift correction skip may occur may have an upper limit. For example, the auxiliary storage device 124 stores information relating to a prescribed number of times that the position shift correction can be skip. The processor 121 and the like may track the number of times the position shift correction has been skipped after a restarting in printing, and record the number in the auxiliary storage device 124. The processor 121 and the like reset the tracked number to an initial value in response to the execution of the first or second position shift correction control.

If the first condition is satisfied and the position shift correction has been skipped the prescribed number of times or less, the processor 121 and the like do not execute the position shift correction (there is a skipping of the position shift correction). However, the processor 121 and the like execute the position shift correction if the first condition is satisfied and the number times the position shift correction is skipped exceeds the prescribed number of times. For example, by setting “1” as the prescribed number of times, the position shift correction control will be executed only once when the first condition is satisfied.

Thus, it is possible to prevent the position shift correction from being skipped over for a long period of time. Specifically, it is possible to suppress excessive position shift correction skipping and prevent the image quality from degrading due to the position shift.

### Second Embodiment

Next, an example of the timing control of the position shift correction according to the second embodiment is described. In the second embodiment, the timing control of the position shift correction based on the temperature change from temperature values detected by a plurality of thermistors (for example, the first temperature sensor 1067 and the second temperature sensor 1068) is described. The processor 121 and the like control the timing of the position shift correction. At least one of the processor 121 and the printer processor 1271 records the temperature values detected by the first temperature sensor 1067 and the second temperature sensor 1068 at a predetermined frequency in the auxiliary storage device 124 or the like, and detects the temperature change from the temperature value recorded in the auxiliary storage device 124.

The timing control of the position shift correction based on the temperature change detected by the first temperature sensor 1067 by the processor 121 and the like is as described in the first embodiment, and thus, the repeated description thereof is omitted. In the second embodiment, in addition to the timing control of the position shift correction based on temperature changes detected by the first temperature sensor 1067 and a temperature change detected by the second temperature sensor 1068 in combination.

The second temperature sensor 1068 is installed at a place where a distance from the heat source, such as the motor 1064, is farther than that of the first temperature sensor 1067. Therefore, the temperature change from the temperature value detected by the second temperature sensor 1068 is gentler (more gradual and with less local (high frequency) variations) than that based on the temperature value detected by the first temperature sensor 1067.

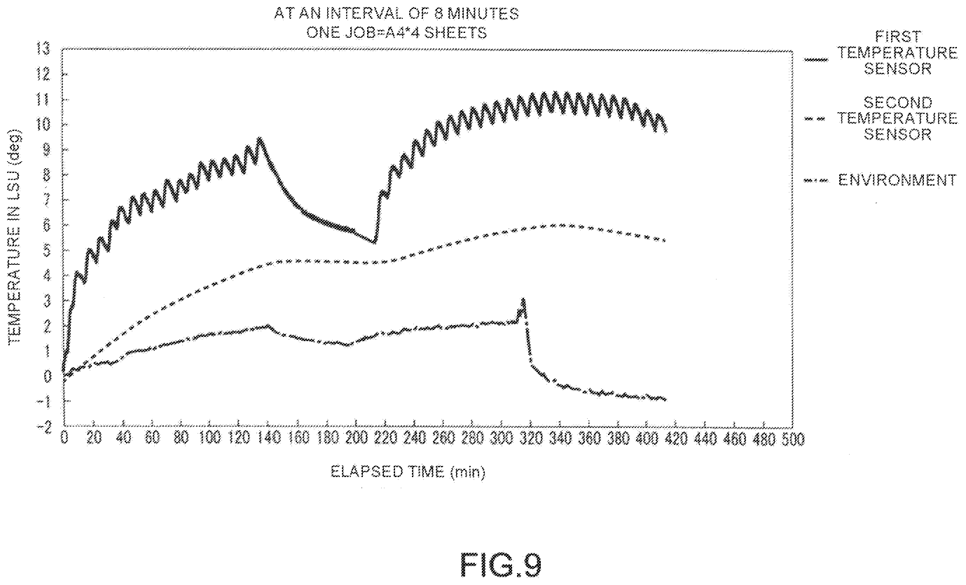

FIG. 9 is a diagram illustrating an example of temperature changes detected by the first temperature sensor 1067 and the second temperature sensor 1068 in the case in which a job is repeated intermittently at an interval of 8 minutes according to the second embodiment. For example, one job is the printing on four sheets of A4 size (A4*4 sheets), and the printing stop period between one job and one job next is about 8 minutes.

As shown in FIG. 9, the first temperature sensor 1067 sees relatively short-term (high-frequency) temperature change. Contrarily, the second temperature sensor 1068 sees only a relatively long-term (low frequency) temperature change. The position shift control based on the temperature change detected by the first temperature sensor 1067 can correct the position shift caused by the displacement of each part due to the influence of the short-term temperature changes. The position shift control based on the temperature change detected by the second temperature sensor 1068 can correct the position shift caused by the displacement of each part due to the influence of a long-term temperature change/drift. By executing the position shift correction based on the temperature changes detected by both the first temperature sensor 1067 and the second temperature sensor 1068, the position shift caused by the influence of the short-term and long-term temperature changes can be corrected.

A temperature change range for the temperature values detected by the second temperature sensor 1068 is generally narrower than a temperature change range for the temperature values detected by the first temperature sensor 1067. The threshold values are set based on this assumption. Similar to that already described for the first temperature sensor 1067, a second threshold value table can be stored in the auxiliary storage device 124 or the like. The threshold values for different temperature change ranges are set by setting using the temperature at the start of printing as a reference temperature such that no change from the initial detected temperature is considered to be a change amount of 0 [deg].

0<temperature change range R21<T21: threshold value TH21
T21≤temperature change range R22<T22: threshold value TH22
T22≤temperature change range R23<T23: threshold value TH23
T23≤temperature change range R24: threshold value TH24

Furthermore, the following relationships hold:

T23−T22<T22−T21<T21;

TH24<TH23<TH22<TH21;

TH21<TH11;

TH22<TH12;

TH23<TH13; and

TH24<TH14.

The processor 121 and the like compare the temperature change detected by the second temperature sensor 1068 with a threshold value, and perform the position shift correction if the temperature change amount exceeds the threshold value. Specifically, the processor 121 and the like compare the temperature change in the temperature value detected by the first temperature sensor 1067 to the threshold value from the first threshold value table, and execute the position shift correction (including potentially execution of a position shift correction skip, depending on the condition); and compare the temperature change detected by the second temperature sensor 1068 to the threshold value in the second threshold value table, and execute the position shift correction accordingly. The position shift correction (including a position shift correction skipping depending on the condition) based on the temperature change detected by the first temperature sensor 1067 and the position shift correction based on the temperature change detected by the second temperature sensor 1068 can be executed independently.

The first temperature sensor 1067 is close to the heat source, such as the motor 1064, and is easily affected by temperature changes caused by the heat source. By skipping a position shift correction associated with temperature changes measured by the first temperature sensors 1067, excessive position shift corrections can be prevented. The second temperature sensor 1068 is far from the heat source such as the motor 1064 and is hardly affected by the temperature change. Therefore, a skipping of a position shift correction associates with temperature changes measured by the second temperature sensor 1068 is not utilized.

According to above-described embodiments, execution of excessive position shift corrections can be suppressed. It is also still possible to correct the position shift caused by the displacements caused by the influences of the short-term and long-term temperature changes.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions, and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. An image forming apparatus, comprising:
a first temperature sensor inside the image forming apparatus and configured to detect a temperature; and
a controller configured to:
execute a first position shift correction for each of a plurality of toner images used in printing an image when the first temperature sensor detects a change in temperature from a previously detected temperature exceeds a first threshold value set for a first temperature range, and
after the first position shift correction, execute a second position shift correction when the detected change in temperature exceeds a second threshold value set for a second temperature range higher than the first temperature range and the temperature is outside a prescribed temperature range, and skip the second position shift correction otherwise.

2. The image forming apparatus according to claim 1, wherein
after the first position shift correction, the controller counts a number of times that the second position shift correction is skipped because the temperature is inside the prescribed temperature range, and
executes the second position shift correction once the number meets or exceeds a predetermined number.

3. The image forming apparatus according to claim 1, wherein the first temperature sensor is a thermistor.

4. The image forming apparatus according to claim 1, wherein the first temperature sensor is inside an optical scanning device of the image forming apparatus.

5. The image forming apparatus according to claim 1, wherein the second threshold value is smaller than the first threshold value.

6. The image forming apparatus according to claim 1, wherein the image is a color image.

7. The image forming apparatus according to claim 1, wherein the plurality of toner images consists of a cyan toner image, a magenta toner image, a yellow toner image, and a black toner image.

8. The image forming apparatus according to claim 1, further comprising:
a second temperature sensor, wherein
a distance between the first temperature sensor and a heat source in the image forming apparatus is less than a distance between the second temperature sensor and the heat source.

9. The image forming apparatus according to claim 8, wherein the first and second temperature sensors are each a thermistor.

10. The image forming apparatus according to claim 8, wherein the first and second temperature sensors are each in an optical scanning device of the image forming apparatus and the heat source is a motor for rotating a polygonal mirror in the optical scanning device.

11. The image forming apparatus according to claim 8, wherein the controller is further configured to execute a position shift correction according to a detected temperature of the second temperature sensor.

12. The image forming apparatus according to claim 1, further comprising:
a second temperature sensor, wherein
a distance between the first temperature sensor and a heat source in the image forming apparatus is greater than a distance between the second temperature sensor and the heat source.

13. The image forming apparatus according to claim 12, wherein the first and second temperature sensors are each a thermistor.

14. The image forming apparatus according to claim 12, wherein
the first and second temperature sensors are each in an optical scanning device of the image forming apparatus, and
the heat source is a motor for rotating a polygonal mirror in the optical scanning device.

15. The image forming apparatus according to claim 12, wherein the controller is further configured to execute a position shift correction according to a detected temperature of the second temperature sensor.

16. A multifunctional peripheral device, comprising:
a laser printing unit configured to print color images on a sheet using a printing process including overlaying a plurality of toner images of different colors;
a first temperature sensor inside the laser printing unit and configured to detect a temperature; and
a controller configured to:
execute a first position shift correction for each of the plurality of toner images when the first temperature sensor detects a change in temperature from a previously detected temperature exceeds a first threshold value set for a first temperature range, and
after the first position shift correction, execute a second position shift correction when the detected change in temperature exceeds a second threshold value set for a second temperature range higher than the first temperature range and the temperature is outside a prescribed temperature range, and skip the second position shift correction otherwise.

17. The multifunctional peripheral device according to claim 16, wherein
after the first position shift correction, the controller counts a number of times that the second position shift correction is skipped because the temperature is inside the prescribed temperature range, and
executes the second position shift correction once the number meets or exceeds a predetermined number.

18. The multifunctional peripheral device according to claim 16, wherein the first temperature sensor is inside an optical scanning device of the laser printing unit.

19. The multifunctional peripheral device according to claim 18, further comprising:
a second temperature sensor, wherein
a distance between the second temperature sensor and a heat source in the laser printing unit is greater than a distance between the first temperature sensor and the heat source, and
the heat source is a motor for rotating a polygonal mirror of the optical scanning device.

20. The multifunctional peripheral device according to claim 19, wherein the controller is further configured to execute a position shift correction according to a detected temperature of the second temperature sensor.
